(19) United States
(12) Patent Application Publication
(10) Pub. No.: US 2024/0037453 A1
(43) Pub. Date: Feb. 1, 2024

(54) EFFICIENT MACHINE LEARNING MESSAGE PASSING ON POINT CLOUD DATA

(71) Applicant: QUALCOMM Incorporated, San Diego, CA (US)

(72) Inventors: Pim DE HAAN, Amsterdam (NL); Taco Sebastiaan COHEN, Amsterdam (NL)

(21) Appl. No.: 18/326,800

(22) Filed: May 31, 2023

Related U.S. Application Data
(60) Provisional application No. 63/369,420, filed on Jul. 26, 2022.

(51) Int. Cl. G06N 20/00; G06N 5/04

(52) U.S. Cl. CPC G06N 20/00; G06N 5/04

(57) ABSTRACT

Certain aspects of the present disclosure provide techniques and apparatus for improved machine learning. Input data comprising a plurality of points in multidimensional space is accessed. An edge connecting a first point and a second point of the plurality of points is identified, and the edge is mapped to a defined axis in the multidimensional space by applying a group element to the edge. An intermediate feature is generated by processing the mapped edge using a neural network. An output feature is generated by applying an inverse of the group element to the intermediate feature, and an output inference is generated based at least in part on the output feature.

### CROSS-REFERENCE TO RELATED APPLICATIONS

This application claims benefit of and priority to U.S. Provisional Patent Application No. 63/369,420, filed Jul. 26, 2022, the entire contents of which are incorporated herein by reference.

### INTRODUCTION

Aspects of the present disclosure relate to machine learning.

Various machine learning architectures have been used to provide solutions for a wide variety of computational problems. For example, machine-learning-based solutions have been provided to generate predictions for point clouds (e.g., a set of points in multidimensional space). However, such tasks are often complex and can be computationally intractable. Invariant point cloud prediction tasks are particularly difficult in at least some conventional systems. For example, it is often desirable that the same prediction be generated for a point cloud, regardless of its pose (e.g., regardless of the point cloud's orientation or rotation, translation, permutation, and the like). At least some conventional approaches to solve point cloud prediction tasks are difficult to implement, and generally incur substantial computational costs.

### BRIEF SUMMARY

Certain aspects provide a processor-implemented method, comprising: accessing input data comprising a plurality of points in multidimensional space; identifying a first edge connecting a first point of the plurality of points and a second point of the plurality of points; mapping the first edge to a defined axis in the multidimensional space by applying a first group element to the first edge; generating a first intermediate feature by processing the mapped first edge using a neural network; generating a first output feature by applying an inverse of the first group element to the first intermediate feature; and generating an output inference based at least in part on the first output feature.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict certain features of example aspects of the present disclosure and are therefore not to be considered limiting of the scope of this disclosure.

FIG. 1 depicts an example workflow for using machine learning to generate inferences using message passing on point clouds.

FIG. 2 depicts an example process for mapping edges in multidimensional space to a canonical edge to improve machine learning efficiency.

FIG. 3 is a flow diagram depicting an example method for generating output inferences using efficient message-passing machine learning models.

FIG. 4 is a flow diagram depicting an example method for efficient message passing.

FIG. 5 is a flow diagram depicting an example method for generating an inference using an improved message-passing machine learning model.

FIG. 6 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and non-transitory computer-readable mediums for improved machine learning models that generate invariant point cloud predictions efficiently.

For example, in some aspects, the point cloud is light detection and ranging (LIDAR) data (e.g., collected by a self-driving or autonomous vehicle), and the presently disclosed techniques and architectures can be used to generate a segmentation of the points into discrete objects (e.g., to identify other vehicles, obstacles, pedestrians, and the like). In some aspects, the point cloud corresponds to molecular structures, and the techniques described herein can be used to predict binding affinity of the molecules. As another example, the point cloud may represent image data (e.g., captured using a fisheye or wide-angle lens), and the techniques described can be used to generate computer-vision-based predictions (e.g., identifying depicted objects in the image). In some aspects, the techniques described herein can be used as a backbone for a molecular sampling network. As another example, the input data may include magnetic resonance imagery (MRI)-derived shapes of arteries of a patient, and the system can predict cardiovascular risk factors. Although these and other specific examples are described in some aspects, aspects of the present disclosure are generally applicable to any point cloud prediction task.

As described in more detail below, aspects of the present disclosure generally improve computational efficiency and model accuracy by reducing the dimensionality of the task. For example, aspects described herein can reduce three-dimensional symmetry to a less complex two-dimensional symmetry of edges, thereby substantially reducing computational expense and model complexity. In some aspects, to do so, the system can map edges in the input point cloud to a canonical edge (e.g., along one axis) using one or more group elements. These canonical edges can then be processed using message passing to generate the feature at one of the points of the mapped edge, and the feature can then be mapped back to the original multidimensional space (e.g., by applying the inverse of the group element). By processing each such edge, the system is able to generate accurate point cloud predictions (which may include predictions for each individual point or edge, and/or predictions for groups of points and/or for the entire point cloud).

In some aspects, each input point cloud may be defined as a set of n points in [symbol] ³ space (e.g., three-dimensional space), such that the data is of shape [symbol] ^{n×3}. Although three-dimensional space is discussed in some examples herein, aspects of the present disclosure are readily applicable to any multidimensional input space (e.g., four-dimensional point clouds, five-dimensional point clouds, and the like). In some aspects, the points in the input data may have additional features, such as to indicate the molecule type of each point. In some aspects, the input data can include a set of edges (e.g., one or more edges, each connecting two or more points). In some aspects, the system can determine, identify, or infer the input edges in the point cloud data (e.g., based on their vicinity in the multidimensional space). For example, the system may infer edges connecting any points that are within a defined distance from each other.

In aspects, as discussed above, the machine learning system may be used to generate predictions (e.g., classifications and/or regression values) for the entire point cloud (or multiple points in the cloud), where the task is defined as f: [symbol] ^{n×3}→ [symbol] . In some aspects, the system may generate predictions for each point, where the task is defined as f: [symbol] ^{n×3}→ [symbol] ⁿ.

Using aspects of the present disclosure, the model can enable a variety of symmetries, where the generated predictions are invariant under translation, rotation, and/or permutation, the global pose may be arbitrary, and the points may not be ordered canonically. In at least one such aspect, for permutations α, f(x_{σ}_{ᵢ})ᵢ₌₁ⁿ=f(x) (where x is a point in the cloud and n is the number of points in the cloud,), and the neural net can perform pair-wise computation to generate invariant predictions. In some aspects, for translations T, f(xᵢ+T)ᵢ₌₁ⁿ=f (x), and the neural net can operate based at least in part on differences xᵢ−xⱼ. In some aspects, for rotations R, f(Rxᵢ)ᵢ₌₁ⁿ=f (x), and the layers of the neural network may be SO(3) equivariant (e.g., equivariant to three-dimensional rotations).

As discussed above, in order to reduce computational complexity and perform efficient point cloud predictions, some aspects of the present disclosure utilize a dimensionality reduction (e.g., reducing three-dimensional symmetry to two-dimensional symmetry of edges). In some aspects, each respective edge (p, q) (e.g., an edge connecting point p to point q in the point cloud) can be mapped to a canonical edge using a respective group element (or set of group elements). As used herein, the canonical edge refers to a defined edge or axis (e.g., along one axis in the multidimensional space, such as the x-axis). For example, mapping an edge to the canonical edge can include applying a set of one or more translations and/or rotations to move one point on the edge (e.g., p) to the origin of the multidimensional space (e.g., (0, 0, 0)) and the other point (e.g., q) to a location on the axis, where the location on the axis is defined based on the distance between the points in the original space. Stated formally, each edge (p, q) can be mapped to the canonical edge ((0,0, 0), (r, 0, 0)), where r is the location of the second point on the x-axis, using a group element g∈SE(3) of translations and rotations, unique up to a planar rotation h∈SO(2).

That is, if there exists a translation t that maps point p to (0, 0, 0) and point q to q-p, then after applying the translation t there exists a rotation R that maps (0, 0, 0) to (0, 0, 0) (e.g., because all rotations preserve the (0,0,0) origin) and maps q-p to (r, 0, 0). However, after applying this rotation R, the system could rotate further along the x-axis by any amount, while preserving both the origin and the point at (r, 0, 0). Therefore, the group element (e.g., a combination of the translation t and rotation r) that maps p and q to (0, 0, 0) and (r, 0, 0), respectively, is not unique. In some aspects, all such transformations can be written as a translation t, then a rotation r, and then a rotation h around the x-axis. These rotations around the x-axis form a group of planar rotations SO(2) (e.g., equivariant to two-dimensional rotations). Thus, the group element is unique until the final rotation h around the x-axis.

Stated differently, for each pair of points (p,q), there exists at least one translation and rotation g∈SE(3) such that gp=(0,0,0) and gq=(r, 0,0), where r=∥q−p∥ (e.g., where r is equal to the distance between the points). In some aspects, therefore, all pairs of points having the same distance between the points can be assigned to the same isomorphism class. In some aspects of the present disclosure, a message-passing kernel (also referred to in some aspects as a convolution kernel) is shared among all edges in the same isomorphism class. That is, edges having a first length are all processed using a first trained/learned kernel, and edges having a second length are processed using a second trained/learned kernel. In at least one aspect, a message-passing kernel is a parameterized transformation or function k_{xy}:Vₓ→V_{y} (e.g., a transformation with learnable or trainable parameters), where Vₓ is the space of features at the base point x and V_{y} is the newly-generated features at the endpoint y. That is, the learned kernel acts as a map from the feature vector space at the start node (e.g., the start of a directional edge, or of one direction of a bidirectional edge) to the feature vector space at the end node (e.g., the end of a directional edge, or the end of one direction of a bidirectional edge).

In some aspects, the message-passing neural network uses such convolution kernels in one or more layers. That is, a learned message-passing kernel may be applied (e.g., by convolving the kernel with features from the origin node to yield output features at the termination node) one or more times (e.g., in one or more layers) to perform message passing. For example, at a first layer/iteration, the input features may include data such as the original coordinates of the start node (e.g., in three-dimensional space). In some aspects, if the nodes have other features (e.g., indicating the type of atom that the node represents in a molecular graph), then these features can additionally or alternatively be included as input to the first layer of the network. The output features from this first layer (generated by processing the input features using a first kernel for the first layer) are then used as input to the second layer, and so on until the output of the final layer.

In some aspects, the system then uses a radius r-dependent network ψᵣ: [symbol] ^{d}→ [symbol] ^{d′}, such that the network is SO(2) equivariant: ∀h∈SO(2), ψr(hv)=hψᵣ(v), where the SO(2) representations on [symbol] ^{d}, [symbol] ^{d′} are the restrictions of SO(3) to the SO(2) subgroup, leaving (1,0,0) invariant. Using such a construction, one may define ϕ(q−p, v)=g⁻¹ψᵣ (g v), where g is the group element, r is the radius of the mapped edge (e.g., the location of the second point on the x-axis), and v is the feature at the first point p. This definition is SE (3) equivariant (e.g., equivariant under continuous three-dimensional roto-translations).

In some aspects, in order to make the network dependent on the radius of the edges, the system finds the maximum radius R (e.g., the maximum edge length, or maximum distance between any two points) in the point cloud, and picks n points

$$\{ 0 , \frac{R}{n - 1} , \frac{2 R}{n - 1} , … , R \}$$

between zero and the maximum radius (where n may be a hyperparameter) at which independent parameters can be created or used. For any radius between these points, in some aspects, the system can linearly interpolate between the nearest points/parameters. Stated differently, for each respective radius

$$\{ 0 , \frac{R}{n - 1} , \frac{2 R}{n - 1} , … , R \} ,$$

the system trains a respective kernel. For any distances between the designated point (e.g., for distances between radii for which a kernel has been trained), the system may linearly interpolate between the adjacent points that have trained kernels in order to find the parameters/kernel to use at these intermediate points. Generally, the parameters of these kernels are learned using a training procedure (e.g., seeking to minimize one or more loss functions using gradient descent).

At runtime, in some aspects, the system therefore determines or identifies which kernel to apply, when processing a given edge, based on the radius of the mapped edge. That is, when processing the features at the origin node using the first layer of the message-passing neural network, the system may identify the radius of the mapped edge, retrieve or access the kernel trained for this radius (or interpolate between adjacent kernels, if the determined radius does not have a specifically-trained kernel), and use this radius-specific kernel to process the input features. This ensures that the network is radius-dependent, and the generated output is based in part on the radius of the edges.

Using aspects of the present disclosure, the system is therefore able to reduce SO(3) equivariance to SO(2) equivariance (or, more generally, reduce SO(N) equivariance to SO(N−1) equivariance). This SO(2) representation is significantly less complex to implement, may use fixed dimensionality, and may enable use of simpler Clebsch-Gordan coefficients resulting in a less complex and more efficient implementation. Similarly, in some aspects, SO(2) non-linearities are less complex to design and use, as compared to conventional SO(3) non-linearities. Additionally, because the disclosed techniques depend on the radius r, not the difference angle between the points q-p, the techniques are less complex and more efficient to implement.

### Example Workflow for Using Machine Learning to Generate Inferences Using Message Passing on Point Clouds

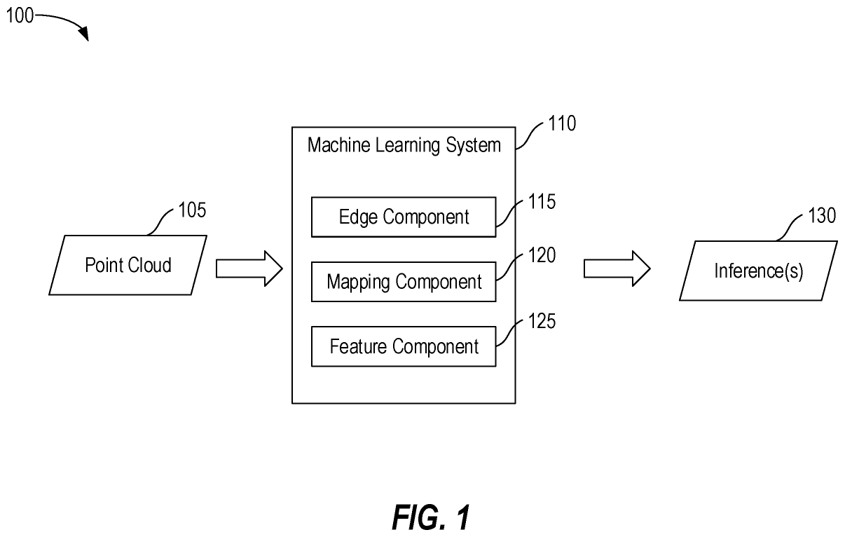

FIG. 1 depicts an example workflow 100 for using machine learning to generate inferences using message passing on point clouds.

In the illustrated workflow 100, a point cloud 105 can be processed by a machine learning system 110 to generate one or more output inferences 130. Although depicted as a discrete system for conceptual clarity, in aspects, the machine learning system 110 may be implemented as a standalone system, or may be implemented as part of a larger system or architecture. The operations of the machine learning system 110 may generally be implemented using hardware, software, or a combination of hardware and software.

As discussed above, the point cloud 105 generally corresponds to a set of points in multidimensional space, where each point has a corresponding location in the space (e.g., defined using a coordinate pair or triplet). In some aspects, the points may include additional features, such as to indicate the type of the point (e.g., the type of molecule the point represents), or other characteristics that may affect the resulting inferences (e.g., that may affect binding affinity of molecules).

As discussed above, in some aspects, the point cloud 105 specifies a set of edges. That is, the input data may itself indicate the relevant edges connecting points in the point cloud 105. In some aspects, the machine learning system 110 can infer or identify edges, such as based on proximity between points in the point cloud 105. In some aspects, the edges may include one or more directional edges (e.g., originating at a first point and terminating at a second) and/or one or more bidirectional edges.

In some aspects, the machine learning system 110 receives or otherwise accesses the point cloud 105 as input (e.g., from a user, or from another system). Although the illustrated workflow 100 depicts the point cloud 105 being accessed form an external source (e.g., outside of the machine learning system 110) for conceptual clarity, in aspects, the point cloud 105 may reside or be received from any suitable location, including within the machine learning system 110 itself.

In the illustrated example, the machine learning system 110 includes an edge component 115, a mapping component 120, and a feature component 125. Although depicted as discrete components for conceptual clarity, in some aspects, the operations of the depicted components may be combined or distributed across any number of components and systems. The edge component 115, mapping component 120, and feature component 125 may be implemented using hardware, software, or a combination of hardware and software.

In some aspects, the edge component 115 may evaluate the point cloud 105 to identify edges in the input data. In some aspects, as discussed above, this can include identifying defined edges that are explicitly included in the point cloud 105. In some aspects, the edge component 115 can identify edges that are not explicitly indicated based on proximity in the multidimensional space. For example, the edge component 115 may identify any points that are within a defined maximum distance from each other in the space, and generate, infer, detect, or identify an edge between these points. In at least one aspect, the edge component 115 can generate or infer an edge connecting every pair of points in the point cloud 105. That is, for each pair of points, the edge component 115 may identify or generate a corresponding edge, such that the point cloud 105 is fully connected.

In some aspects, the mapping component 120 can map the identified edges (e.g., identified by the edge component 115) in the point cloud 105 to a canonical edge, as discussed above. For example, the mapping component 120 may find or use a group element g∈SE(3) (e.g., a three-dimensional translation (which may be represented by a [symbol] ³ vector) combined with a 3×3 rotation matrix) that maps each edge from (p, q) to ((0,0,0), (r, 0,0)). In some aspects, as rotating the mapped edge around this canonical edge results in the same edge/vector (e.g., the mapped edge is rotationally invariant around the x-axis, if the canonical edge is along the x-axis), there may be a set of group elements (e.g., a group of planar rotations) that map any given edge to the canonical edge. In some aspects, the group element(s) may be computed using linear algebra.

In the illustrated example, the mapping component 120 may thereby move the feature v of a first point in a given edge p to the origin (e.g., to (0,0,0)) by applying the group element g for the edge.

As illustrated, the feature component 125 can use an invariant message-passing network (a neural network) to bring the message from the origin (e.g., the feature v mapped using the group element) to the endpoint of the edge (e.g., at (r, 0,0)). In some aspects, this use of a neural network to generate features at each point based on “messages” from connected points is referred to as “message passing.” In some aspects, the feature component 125 corresponds to or uses a trained neural network that receives, as input, the feature of the first point on the edge (also referred to as the “state” in some aspects), and processes this feature based on the radius r to generate the feature at the second point on the edge.

In some aspects, the feature component 125 aggregates these messages across multiple edges to create one or more new features at each point by aggregating (e.g., summing) over the edges connecting to that point. That is, for each point, the feature component 125 can identify the edges connecting to the point, generate a respective intermediate feature for each respective edge by using the neural network to perform message passing along the respective edge, and then sum or otherwise aggregate these intermediate features to yield the new feature for the point.

In the workflow 100, the mapping component 120 can then map the generated output feature for each point back to the original multidimensional space of the input point cloud 105. For example, by applying the inverse of the group element (g⁻¹), the mapping component 120 can move the output feature from the canonical edge (e.g., at (r, 0,0)) back to the original space in the point cloud 105 (e.g., to q).

In some aspects, as discussed above, some or all of the edges may be bidirectional. In at least one such aspect, for a given bidirectional edge connecting points p and q, the mapping component 120 can generate an output feature for point q in part by processing a state or feature (e.g., a prior feature or state from a prior iteration, or specified in the point cloud 105) of point p using the network, and also generate an output feature for point q in part by processing the state or feature of point q (e.g., from a prior iteration or specified in the point cloud 105) using the network.

In some aspects, these operations can be repeated for each edge and/or point in the point cloud 105. That is, the mapping component 120 can similarly map and process all edges to generate output features for each point in the cloud. In some aspects, these features can then be used to generate the output inference(s) 130. For example, in the case of point-specific inferences, the mapping component 120 can process each respective point feature to generate an inference 130 for the respective point (e.g., a classification or regression value). In the case of an inference 130 covering the whole point cloud 105, the mapping component 120 may process some or all of the features to generate an overall inference (e.g., a classification or regression value for the entire point cloud 105).

As discussed above, these inferences 130 may be used for a variety of purposes depending on the particular implementation. For example, the point cloud 105 may correspond to molecular information, and the inferences 130 can indicate predicted binding affinities of the molecules. As another example, the point cloud 105 may include LIDAR data, and the inferences 130 can include segmentations, object detections and/or classifications, and the like. As yet another example, the point cloud 105 may include image data (e.g., captured using a wide-angle lens, such that the image data covers an angle of view equal to or greater than sixty degrees), and the inferences 130 may include image recognition or processing output, such as object detection and/or classification. As still another example, the point cloud 105 may include MRI data (e.g., structural data about a patient's artery shape and structure), and the inferences 130 may include predictions related to the patient's susceptibility or risk for various diseases and disorders.

### Example Process for Mapping Edges in Multidimensional Space to a Canonical Edge to Improve Machine Learning Efficiency

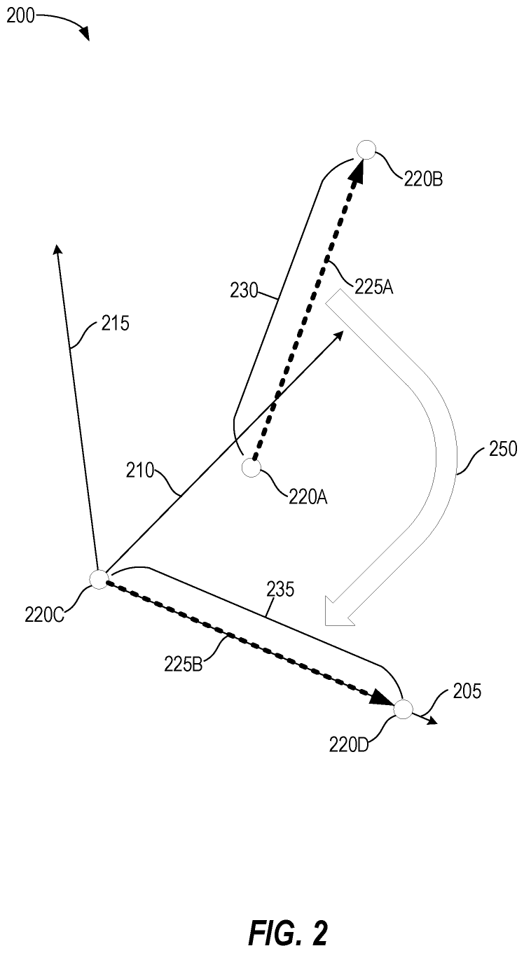

FIG. 2 depicts an example process 200 for mapping edges in multidimensional space to a canonical edge to improve machine learning efficiency. In some aspects, the process 200 is performed by a machine learning system, such as the machine learning system 110 of FIG. 1.

In the process 200, a multidimensional vector space having three dimensions is depicted. Specifically, one dimension is defined by a first axis 205, a second dimension is defined by a second axis 210, and a third dimension is defined by a third axis 215, where each axis is perpendicular to each other axis. Although a three-dimensional space is depicted for conceptual clarity, in aspects, there may be any number of dimensions in the space. The depicted multidimensional space generally corresponds to the dimensionality of the input point cloud.

In the illustrated example, the point cloud includes at least a first point 220A and a second point 220B. As discussed above, each point 220A and 220B generally has a specified location in the multidimensional space (e.g., a set of coordinates, one value for each axis). In some aspects, some or all of the points 220A and 220B may include additional features or information, such as identifying or indicating the type of molecule each point represents. Although two points 220A and 220B are depicted for conceptual clarity, in aspects, there may be any number of points in a given point cloud.

As illustrated, the points 220A and 220B are connected by an edge 225A. Although the illustrated example depicts the edge 225A as directional (e.g., originating at point 220A and terminating at point 220B), in some aspects, the edge 225A may be bidirectional. In some aspects, the edge 225A can be defined or represented based on the length or distance between the points 220A and 220B (indicated by 230) and the direction of the connection (e.g., a set of angles in three-dimensional space indicating the directionality of the vector). As discussed above, the edge 225A may have been specified in the point cloud data, or may be determined or inferred (e.g., based on proximity of the points 220A and 220B) by the system, such as by the edge component 115 of FIG. 1.

As discussed above, generating inferences for point clouds in the original multidimensional space (e.g., in three-dimensional space) involves substantial computational resources, and introduces significant complexity and latency. In the illustrated example, therefore, the system (e.g., a mapping component 120 of FIG. 1) can apply a group element (indicated by arrow 250) to move the edge 225A to align with a canonical edge. For example, as discussed above, applying the group element may involve applying a set of translations and/or rotations to the edge 225A to move the edge 225A in order to align with the canonical edge. In some aspects, as discussed above, this group element (or set of group elements) may be precomputed using a variety of techniques.

In the illustrated example, the canonical edge aligns with the axis 205. However, in aspects, the canonical edge or axis may generally correspond to any straight line in the multidimensional space. For example, the system may use group elements to map edges to the axis 215, to the axis 210, or to some arbitrary line (which may lie offset from all axes in the space).

In the illustrated example, mapping the edge 225A to the canonical edge includes moving the point 220A to the origin of the space (indicated by point 220C), and moving the point 220B to a position along the canonical edge, where the specific position is dictated by the length of the edge 225A/distance between the points 220A and 220B. Specifically, as illustrated, the point 220B is mapped to the point 220D, which is at a distance or radius r from the origin, as indicated by 235.

As discussed above, in some aspects, the edge 225B, which has been mapped to the canonical edge/axis, is equivariant with respect to rotation around the axis 205. That is, rotating the edge 225B around the axis 205 corresponds to rotating the edge around the edge's own length, which does not change the direction or magnitude of the vector. This allows the system to perform invariant inferencing on the point cloud, by performing message passing along the axis 205 (e.g., along the edge 225B, from point 220C to point 220D).

In some aspects, as discussed above, the machine learning system (e.g., a feature component 125 of FIG. 1) can then use a message-passing neural network to generate an output feature at point 220D based on the edge 225B and/or state of the point 220C. As discussed above, this feature can then be mapped back to the original multidimensional space by applying the inverse of the group element (indicated by arrow 250).

In some aspects, by performing the process 200 for each edge in the point cloud, the system is able to efficiently generate inferences for point clouds using natural message passing to generate invariant output that can accurately represent or reflect the point cloud (e.g., using classification or regression) regardless of the cloud's permutation, translation, or rotation.

### Example Method for Generating Output Inferences Using Efficient Message-Passing Machine Learning Models

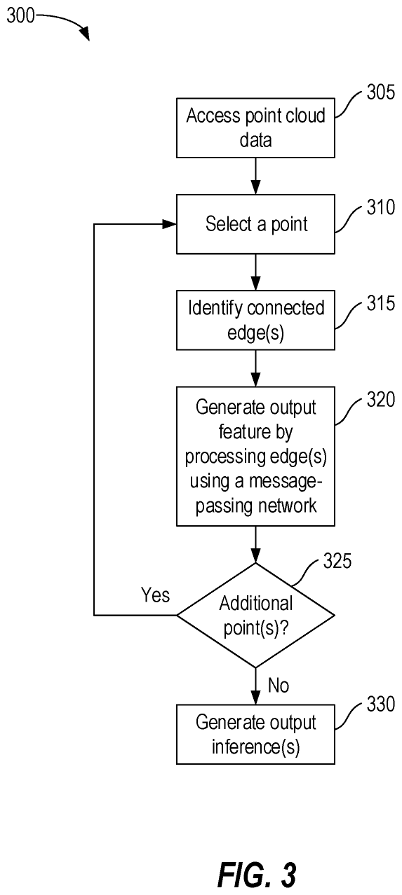

FIG. 3 is a flow diagram depicting an example method 300 for generating output inferences using efficient message-passing machine learning models. In some aspects, the method 300 is performed by a machine learning system, such as the machine learning system 110 of FIG. 1.

At block 305, the machine learning system accesses input point cloud data. As discussed above, the point cloud data generally corresponds to a set of points in multidimensional space, where each point has a corresponding location in the space (e.g., defined using a set of coordinates). In some aspects, the points may include additional features, such as to indicate the type of each point or any other characteristics that may affect the resulting inferences. As discussed above, in some aspects, the point cloud data specifies a set of edges. That is, the input data may itself indicate the relevant edges connecting points in the point cloud. In some aspects, the machine learning system can infer or identify edges, such as based on proximity between points in the point cloud.

In some aspects, the machine learning system accesses the point cloud data as input (e.g., from a user, or from another system) for a machine learning model. Generally, accessing the point cloud data can include receiving the data from another system or device (or from a user), retrieving the data from another system or device (or from a location within the machine learning system), and the like.

At block 310, the machine learning system selects one of the points indicated in the point cloud data. Generally, the machine learning system may select the point using any suitable criteria or technique, as all of the points will be processed using the method 300. Although the illustrated method 300 depicts selecting and processing the points sequentially for conceptual clarity, in some aspects, some or all of the points may be processed in parallel.

At block 315, the machine learning system identifies a set of connected edges for the selected point. That is, the machine learning system identifies edges that include the selected point as an endpoint. As discussed above, in some aspects, the edges are specified in the input point cloud data. In some aspects, the machine learning system can infer or identify the edges based on proximity in the space (e.g., where edges can be added or inferred for any points that are within a threshold distance of each other).

In some aspects, as discussed above, the edges may be bidirectional and/or directional. In at least one aspect, if the edges are bidirectional, then the machine learning system can identify all connected (bidirectional) edges to the point. In some aspects, in the case of directional edges, the machine learning system may identify all edges that end or terminate at the selected point.

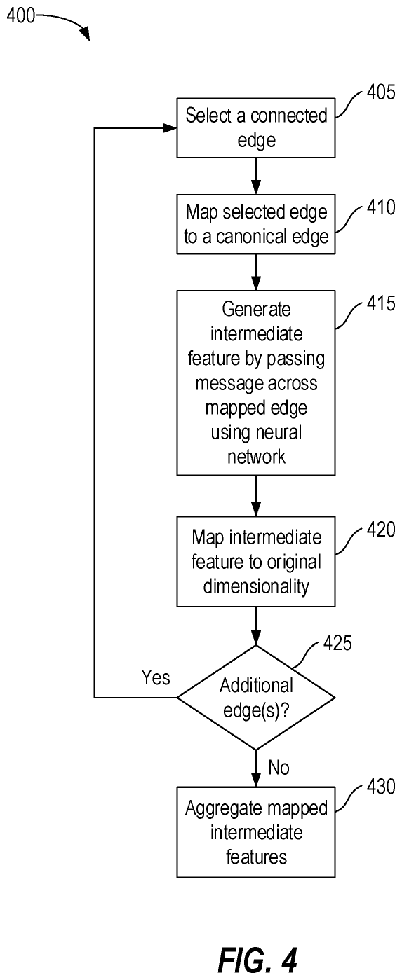

At block 320, the machine learning system can generate an output feature (e.g., a vector) for the selected point based on processing the identified edge(s) using a message-passing neural network. In some aspects, as discussed above, the machine learning system may do so by first mapping each edge to a canonical edge or axis, using the message-passing network to generate intermediate features on this axis, mapping the intermediate features back to the original vector space, and aggregating the resulting feature from each identified edge (e.g., by summing the resulting features). One example of generating the output feature for the selected point is described in more detail below with reference to FIG. 4.

At block 325, the machine learning system determines whether there is at least one additional point remaining in the point cloud data that has not yet been evaluated. If so, then the method 300 returns to block 310. If an output feature has been generated for each point, then the method 300 continues to block 330.

At block 330, the machine learning system generates one or more output inferences based on the output features generated for each point in the point cloud data. As discussed above, the output inference(s) may generally include a classification and/or regression value for each point, a classification and/or regression value for one or more sets of points (e.g., for the whole point cloud), and the like. In some aspects, the machine learning system generates the output inference by processing the output features using one or more machine learning models (e.g., one or more layers of a neural network). Generally, the specific operations used to generate the output inference may vary depending on the particular implementation and task.

As one example, the machine learning system may generate the equivariant network output [symbol] ^{d}-invariant features (which are unchanging under rotations) for each node in the point cloud, then use a multilayer perceptron (MLP) with several layers to output a single number for each node (based on the corresponding features), which can then be used as a classification logit of the respective node. For example, for a molecular graph, the logit may correspond to a prediction as to whether another molecule would bind at the atom represented by the node.

### Example Method for Efficient Message Passing

FIG. 4 is a flow diagram depicting an example method 400 for efficient message passing. In some aspects, the method 400 is performed by a machine learning system, such as the machine learning system 110 of FIG. 1. The method 400 may provide additional detail for block 320 of FIG. 3. In some aspects, the method 400 is performed for each point in the input point cloud.

At block 405, the machine learning system selects an edge that is connected to a given point (e.g., from the set of edges, determined at block 315 of FIG. 3, that are connected to the point selected at block 310 of FIG. 3). Generally, the machine learning system may select the edge using any suitable criteria or technique, as all of the connected edges will be processed using the method 400. Although the illustrated method 400 depicts selecting and processing the edges sequentially for conceptual clarity, in some aspects, some or all of the edges may be processed in parallel.

At block 410, the machine learning system maps the selected edge to a predefined canonical edge or axis, as discussed above. For example, the machine learning system may apply a group element to map or move the selected edge to the canonical edge or axis (e.g., to align with the x-axis, where the starting point for the edge is located at the origin in the space, and the terminating point is located along the defined axis, at a distance defined based on the distance between the points in the original space). In this way, the machine learning system can generate an output feature for the point based on the radius r, without consideration for the original difference angle between the points.

At block 415, the machine learning system generates an intermediate feature (e.g., a feature vector or tensor) for the point by performing natural message passing across the mapped edge (along the canonical edge or axis) using a message-passing neural network, as discussed above.

For example, for an input feature v at (0, 0, 0) that transforms under SO(3) rotations, there is a SO(2) group of rotations (around the x-axis), and the system can transform v equivariantly to that SO(2) group. In at least one such aspect, to create or build a linear layer for the message-passing network, the SO(2) equivariance gives linear constraints on the linear transformations, which can be solved analytically. In some systems, the learnable parameters can then be used to linearly combine the solutions in order to create an equivariant linear layer (as well as combining the solutions to yield non-linearities, in some aspects). In some aspects of the present disclosure, the message-passing neural network uses one linear layer constructed in this way, one non-linear layer, and one final linear layer.

In this way, the message-passing neural network comprises a set of one or more layers (which are constructed based on various constraints for equivariance) having learned/trained parameters, where the network serves to transform or map features at the origin into corresponding features at the other end of edges that are mapped to the canonical edge.

For example, as discussed above, the system may identify or select a trained kernel (or interpolate between adjacent kernels) based on the radius of the mapped edge (thereby ensuring the network is radius-dependent), and use this trained kernel to process the features at the origin point (e.g., using convolution) to generate output features (e.g., for the endpoint of the edge). This convolution may be repeated one or more times (e.g., for one or more layers of the network) to generate the output for the given point. That is, for a given mapped edge with radius r, the system can retrieve or access the kernel that was trained for edges with radius r, if one exists. If not, then the system can identify the adjacent kernels (e.g., at rᵢ and rⱼ, where rᵢ is the radius that is closest to but less than r, where a kernel was trained for the specific radius rᵢ, and rⱼ is the radius that is closest to but greater than r, where a kernel was trained for the specific radius rⱼ. The system may then linearly interpolate between these trained kernels rᵢ and rⱼ to generate a kernel for radius r, and use this kernel to convolve the input features of the edge.

At block 420, the machine learning system maps the intermediate feature (generated at block 415 based on the selected edge) back to the original dimensionality of the vector space of the input point cloud. For example, as discussed above, the machine learning system may apply the inverse of the group element to map the feature back to the original space.

At block 425, the machine learning system determines whether there is at least one additional edge, from the set of connected edges, that has not yet been evaluated. If so, then the method 400 returns to block 405. If all connected edges have been processed, then the method 400 continues to block 430.

At block 430, the machine learning system aggregates the mapped intermediate features (generated at block 420) that were generated for each connected edge. For example, the machine learning system may compute the sum of these intermediate features to generate an overall output feature (e.g., a vector or tensor) for the point.

In this way, the machine learning system can generate an output feature for each point by performing equivariant natural message passing, in a reduced dimensionality space, along each connected edge for the point. This allows the machine learning system to efficiently generate output features for the points, thereby significantly reducing the computational complexity and expense of processing the point cloud data.

Example Method for Generating an Inference Using Improved Message Passing

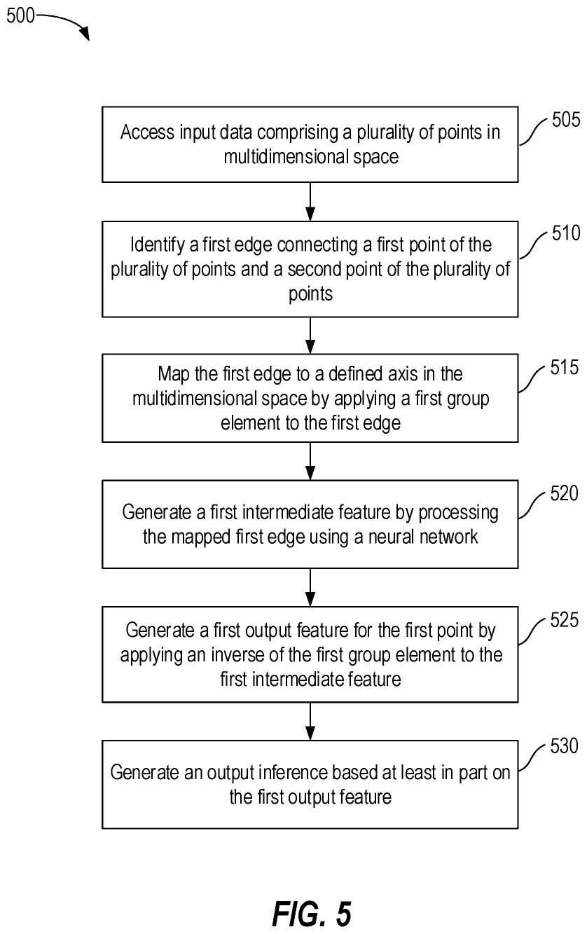

FIG. 5 is a flow diagram depicting an example method 500 for generating an inference using improved message passing. In some aspects, the method 500 is performed by a machine learning system, such as the machine learning system 110 of FIG. 1.

At block 505, input data comprising a plurality of points in multidimensional space is accessed.

At block 510, a first edge connecting a first point of the plurality of points and a second point of the plurality of points is identified.

At block 515, the first edge is mapped to a defined axis in the multidimensional space by applying a first group element to the first edge.

At block 520, a first intermediate feature is generated by processing the mapped first edge using a neural network.

At block 525, a first output feature is generated by applying an inverse of the first group element to the first intermediate feature.

At block 530, an output inference is generated based at least in part on the first output feature.

In some aspects, the method 500 further includes generating a plurality of output features based on the plurality of points and generating the output inference based on the plurality of output features.

In some aspects, the method 500 further includes computing, for each respective edge in the input data, a respective group element to map the respective edge to the defined axis.

In some aspects, identifying the first edge comprises determining that the first point and the second point are within a defined distance in the multidimensional space.

In some aspects, the first edge is specified in the input data.

In some aspects, the first group element comprises a set of translations and a set of rotations that map the first edge to the defined axis.

In some aspects, applying the first group element causes the second point to move to an origin in the multidimensional space and the first point to move to the defined axis of the multidimensional space at a distance r from the origin, wherein the distance r is defined based on a length of the first edge.

In some aspects, the neural network is an invariant message-passing network, and the first output feature for the first point is generated further based on summing messages over a set of edges connected to the first point.

In some aspects, the output inference corresponds to one or more of: a segmentation of the plurality of points into objects, wherein the input data corresponds to light detection and ranging (LIDAR) data, a predicted binding affinity of molecules, wherein the input data corresponds to molecular structures, or a computer vision prediction, wherein the input data corresponds to image data (e.g., captured using a wide-angle lens).

In some aspects, processing the mapped first edge using the neural network comprises: determining a length of the first edge; accessing a convolution kernel based on the length of the first edge; and convolving one or more features of the second point with the convolution kernel.

In some aspects, accessing the convolution kernel comprises, in response to determining that the convolution kernel was trained based on edges having lengths equal to the length of the first edge, determining to use the convolution kernel to process the mapped first edge.

In some aspects, accessing the convolution kernel comprises, in response to determining that no kernels in the neural network were trained based on edges having lengths equal to the length of the first edge: accessing a first kernel trained based on edges shorter than the length of the first edge; accessing a second kernel trained based on edges longer than the length of the first edge; and generating the convolution kernel by interpolating between the first kernel and the second kernel.

Example Processing System

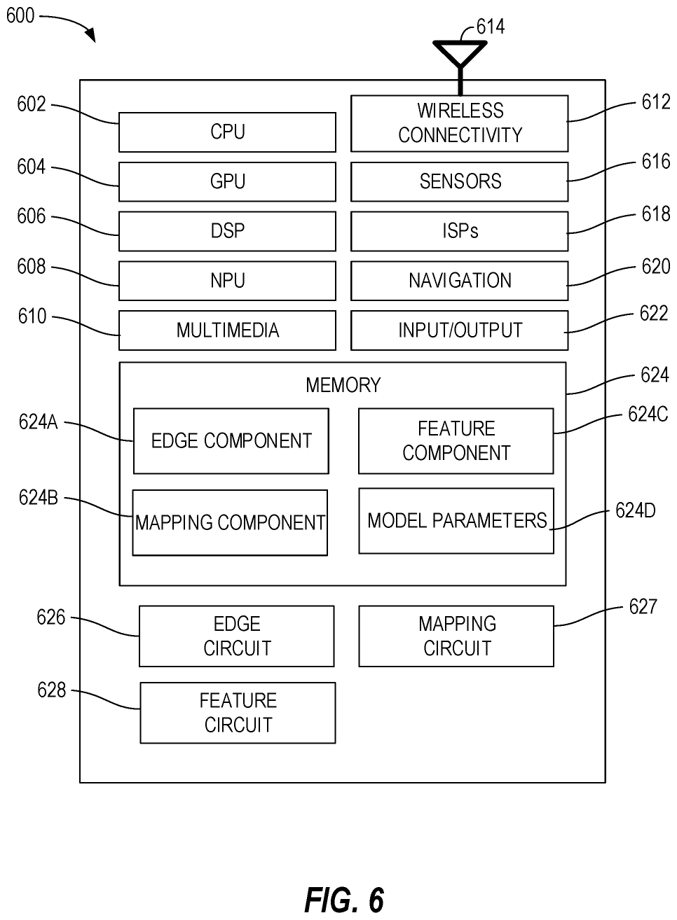

In some aspects, the workflows, techniques, and methods described with reference to FIGS. 1-5 may be implemented on one or more devices or systems. FIG. 6 depicts an example processing system 600 configured to perform various aspects of the present disclosure, including, for example, the techniques and methods described with respect to FIGS. 1-5. In some aspects, the processing system 600 may correspond to a machine learning system, such as the machine learning system 110 of FIG. 1. Although depicted as a single system for conceptual clarity, in at least some aspects, as discussed above, the operations described below with respect to the processing system 600 may be distributed across any number of devices or systems.

Processing system 600 includes a central processing unit (CPU) 602, which in some examples may be a multi-core CPU. Instructions executed at the CPU 602 may be loaded, for example, from a program memory associated with the CPU 602 or may be loaded from a memory partition (e.g., a partition of memory 624).

Processing system 600 also includes additional processing components tailored to specific functions, such as a graphics processing unit (GPU) 604, a digital signal processor (DSP) 606, a neural processing unit (NPU) 608, a multimedia component 610 (e.g., a multimedia processing unit), and a wireless connectivity component 612.

An NPU, such as NPU 608, is generally a specialized circuit configured for implementing the control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing units (TPU), neural network processor (NNP), intelligence processing unit (IPU), vision processing unit (VPU), or graph processing unit.

NPUs, such as NPU 608, are configured to accelerate the performance of common machine learning tasks, such as image classification, machine translation, object detection, and various other predictive models. In some examples, a plurality of NPUs may be instantiated on a single chip, such as a system on a chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this piece through an already trained model to generate a model output (e.g., an inference).

In some implementations, NPU 608 is a part of one or more of CPU 602, GPU 604, and/or DSP 606.

In some examples, wireless connectivity component 612 may include subcomponents, for example, for third generation (3G) connectivity, fourth generation (4G) connectivity (e.g., 4G LTE), fifth generation connectivity (e.g., 5G or NR), Wi-Fi connectivity, Bluetooth connectivity, and other wireless data transmission standards. Wireless connectivity component 612 is further coupled to one or more antennas 614.

Processing system 600 may also include one or more sensor processing units 616 associated with any manner of sensor, one or more image signal processors (ISPs) 618 associated with any manner of image sensor, and/or a navigation processor 620, which may include satellite-based positioning system components (e.g., GPS or GLONASS) as well as inertial positioning system components.

Processing system 600 may also include one or more input and/or output devices 622, such as screens, touch-sensitive surfaces (including touch-sensitive displays), physical buttons, speakers, microphones, and the like.

In some examples, one or more of the processors of processing system 600 may be based on an ARM or RISC-V instruction set.

Processing system 600 also includes memory 624, which is representative of one or more static and/or dynamic memories, such as a dynamic random access memory, a flash-based static memory, and the like. In this example, memory 624 includes computer-executable components, which may be executed by one or more of the aforementioned processors of processing system 600.

In particular, in this example, memory 624 includes an edge component 624A, a mapping component 624B, and a feature component 624C. The memory 624 also includes a set of model parameters 624D. Though depicted as discrete components for conceptual clarity in FIG. 6, the illustrated components (and others not depicted) may be collectively or individually implemented in various aspects.

The model parameters 624D may generally correspond to the parameters of all or a part of one or more machine learning models, such as one or more message-passing neural networks, as discussed above.

Processing system 600 further comprises edge circuit 626, mapping circuit 627, and feature circuit 628. The depicted circuits, and others not depicted, may be configured to perform various aspects of the techniques described herein.

For example, edge component 624A and edge circuit 626 (which may correspond to the edge component 115 of FIG. 1) may be used to identify edges in point cloud data, as discussed above. Mapping component 624B and mapping circuit 627 (which may correspond to the mapping component 120 of FIG. 1) may be used to map edges in the original space to a canonical edge or axis, and/or to map the generated features back to the original space, as discussed above. Feature component 624C and feature circuit 628 (which may correspond to the feature component 125 of FIG. 1) may be used to perform message passing (e.g., using a message-passing neural network including the model parameters 624D), as discussed above.

Though depicted as separate components and circuits for clarity in FIG. 6, edge circuit 626, mapping circuit 627, and feature circuit 628 may collectively or individually be implemented in other processing devices of processing system 600, such as within CPU 602, GPU 604, DSP 606, NPU 608, and the like.

Generally, processing system 600 and/or components thereof may be configured to perform the methods described herein.

Notably, in other aspects, components of processing system 600 may be omitted, such as where processing system 600 is a server computer or the like. For example, multimedia component 610, wireless connectivity component 612, sensor processing units 616, ISPs 618, and/or navigation processor 620 may be omitted in other aspects. Further, components of processing system 600 may be distributed between multiple devices.

### EXAMPLE CLAUSES

Implementation examples are described in the following numbered clauses:
Clause 1: A method, comprising: accessing input data comprising a plurality of points in multidimensional space; identifying a first edge connecting a first point of the plurality of points and a second point of the plurality of points; mapping the first edge to a defined axis in the multidimensional space by applying a first group element to the first edge; generating a first intermediate feature by processing the mapped first edge using a neural network; generating a first output feature by applying an inverse of the first group element to the first intermediate feature; and generating an output inference based at least in part on the first output feature.
Clause 2: A method according to Clause 1, further comprising: generating a plurality of output features based on the plurality of points; and generating the output inference based on the plurality of output features.
Clause 3: A method according to any of Clauses 1-2, further comprising computing, for each respective edge in the input data, a respective group element to map the respective edge to the defined axis.
Clause 4: A method according to any of Clauses 1-3, wherein identifying the first edge comprises determining that the first point and the second point are within a defined distance in the multidimensional space.
Clause 5: A method according to any of Clauses 1-4, wherein the first edge is specified in the input data.
Clause 6: A method according to any of Clauses 1-5, wherein the first group element comprises a set of translations and a set of rotations that map the first edge to the defined axis.
Clause 7: A method according to any of Clauses 1-6, wherein applying the first group element causes the second point to move to an origin in the multidimensional space and the first point to move to the defined axis of the multidimensional space at a distance r from the origin, wherein the distance r is defined based on a length of the first edge.
Clause 8: A method according to any of Clauses 1-7, wherein: the neural network is an invariant message-passing network, and the first output feature for the first point is generated further based on summing messages over a set of edges connected to the first point.
Clause 9: A method according to any of Clauses 1-8, wherein processing the mapped first edge using the neural network comprises: determining a length of the first edge; accessing a convolution kernel based on the length of the first edge; and convolving one or more features of the second point with the convolution kernel.
Clause 10: A method according to any of Clauses 1-9, wherein accessing the convolution kernel comprises, in response to determining that the convolution kernel was trained based on edges having lengths equal to the length of the first edge, determining to use the convolution kernel to process the mapped first edge.
Clause 11: A method according to any of Clauses 1-10, wherein accessing the convolution kernel comprises, in response to determining that no kernels in the neural network were trained based on edges having lengths equal to the length of the first edge: accessing a first kernel trained based on edges shorter than the length of the first edge; accessing a second kernel trained based on edges longer than the length of the first edge; and generating the convolution kernel by interpolating between the first kernel and the second kernel.
Clause 12: A method according to any of Clauses 1-11, wherein the output inference corresponds to one or more of: a segmentation of the plurality of points into objects, wherein the input data corresponds to light detection and ranging (LIDAR) data, a predicted binding affinity of molecules, wherein the input data corresponds to molecular structures, or a computer vision prediction, wherein the input data corresponds to image data.
Clause 13: A processing system, comprising: a memory comprising computer-executable instructions; and one or more processors configured to execute the computer-executable instructions and cause the processing system to perform a method in accordance with any of Clauses 1-12.
Clause 14: A processing system, comprising means for performing a method in accordance with any of Clauses 1-12.
Clause 15: A non-transitory computer-readable medium comprising computer-executable instructions that, when executed by one or more processors of a processing system, cause the processing system to perform a method in accordance with any of Clauses 1-12.
Clause 16: A computer program product embodied on a computer-readable storage medium comprising code for performing a method in accordance with any of Clauses 1-12.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A computer-implemented method, comprising:
accessing input data comprising a plurality of points in multidimensional space;
identifying a first edge connecting a first point of the plurality of points and a second point of the plurality of points;
mapping the first edge to a defined axis in the multidimensional space by applying a first group element to the first edge;
generating a first intermediate feature by processing the mapped first edge using a neural network;
generating a first output feature by applying an inverse of the first group element to the first intermediate feature; and
generating an output inference based at least in part on the first output feature.

2. The computer-implemented method of claim 1, further comprising:
generating a plurality of output features based on the plurality of points; and
generating the output inference based on the plurality of output features.

3. The computer-implemented method of claim 1, further comprising computing, for each respective edge in the input data, a respective group element to map the respective edge to the defined axis.

4. The computer-implemented method of claim 1, wherein identifying the first edge comprises determining that the first point and the second point are within a defined distance in the multidimensional space.

5. The computer-implemented method of claim 1, wherein the first edge is specified in the input data.

6. The computer-implemented method of claim 1, wherein the first group element comprises a set of translations and a set of rotations that map the first edge to the defined axis.

7. The computer-implemented method of claim 6, wherein applying the first group element causes the second point to move to an origin in the multidimensional space and the first point to move to the defined axis of the multidimensional space at a distance r from the origin, wherein the distance r is defined based on a length of the first edge.

8. The computer-implemented method of claim 1, wherein:
the neural network is an invariant message-passing network, and
the first output feature for the first point is generated further based on summing messages over a set of edges connected to the first point.

9. The computer-implemented method of claim 1, wherein processing the mapped first edge using the neural network comprises:
determining a length of the first edge;
accessing a convolution kernel based on the length of the first edge; and
convolving one or more features of the second point with the convolution kernel.

10. The computer-implemented method of claim 9, wherein accessing the convolution kernel comprises, in response to determining that the convolution kernel was trained based on edges having lengths equal to the length of the first edge, determining to use the convolution kernel to process the mapped first edge.

11. The computer-implemented method of claim 9, wherein accessing the convolution kernel comprises, in response to determining that no kernels in the neural network were trained based on edges having lengths equal to the length of the first edge:
accessing a first kernel trained based on edges shorter than the length of the first edge;
accessing a second kernel trained based on edges longer than the length of the first edge; and
generating the convolution kernel by interpolating between the first kernel and the second kernel.

12. The computer-implemented method of claim 1, wherein the output inference corresponds to one or more of:
a segmentation of the plurality of points into objects, wherein the input data corresponds to light detection and ranging (LIDAR) data,
a predicted binding affinity of molecules, wherein the input data corresponds to molecular structures, or
a computer vision prediction, wherein the input data corresponds to image data.

13. A processing system, comprising:
a memory comprising computer-executable instructions; and
one or more processors configured to execute the computer-executable instructions and cause the processing system to perform an operation comprising:
accessing input data comprising a plurality of points in multidimensional space;
identifying a first edge connecting a first point of the plurality of points and a second point of the plurality of points;
mapping the first edge to a defined axis in the multidimensional space by applying a first group element to the first edge;
generating a first intermediate feature by processing the mapped first edge using a neural network;
generating a first output feature by applying an inverse of the first group element to the first intermediate feature; and
generating an output inference based at least in part on the first output feature.

14. The processing system of claim 13, the operation further comprising computing, for each respective edge in the input data, a respective group element to map the respective edge to the defined axis.

15. The processing system of claim 13, wherein identifying the first edge comprises determining that the first point and the second point are within a defined distance in the multidimensional space.

16. The processing system of claim 13, wherein the first edge is specified in the input data.

17. The processing system of claim 13, wherein:
the first group element comprises a set of translations and a set of rotations that map the first edge to the defined axis, and
applying the first group element causes the second point to move to an origin in the multidimensional space and the first point to move to the defined axis of the multidimensional space at a distance r from the origin, wherein the distance r is defined based on a length of the first edge.

18. The processing system of claim 13, wherein:
the neural network is an invariant message-passing network, and
the first output feature for the first point is generated further based on summing messages over a set of edges connected to the first point.

19. The processing system of claim 13, wherein processing the mapped first edge using the neural network comprises:
determining a length of the first edge;
accessing a convolution kernel based on the length of the first edge; and
convolving one or more features of the second point with the convolution kernel.

20. The processing system of claim 19, wherein accessing the convolution kernel comprises, in response to determining that the convolution kernel was trained based on edges having lengths equal to the length of the first edge, determining to use the convolution kernel to process the mapped first edge.

21. The processing system of claim 19, wherein accessing the convolution kernel comprises, in response to determining that no kernels in the neural network were trained based on edges having lengths equal to the length of the first edge:
accessing a first kernel trained based on edges shorter than the length of the first edge;
accessing a second kernel trained based on edges longer than the length of the first edge; and
generating the convolution kernel by interpolating between the first kernel and the second kernel.

22. The processing system of claim 13, wherein the output inference corresponds to one or more of:
a segmentation of the plurality of points into objects, wherein the input data corresponds to light detection and ranging (LIDAR) data,
a predicted binding affinity of molecules, wherein the input data corresponds to molecular structures, or
a computer vision prediction, wherein the input data corresponds to image data.

23. A non-transitory computer-readable medium comprising computer-executable instructions that, when executed by one or more processors of a processing system, cause the processing system to perform an operation comprising:
accessing input data comprising a plurality of points in multidimensional space;
identifying a first edge connecting a first point of the plurality of points and a second point of the plurality of points;
mapping the first edge to a defined axis in the multidimensional space by applying a first group element to the first edge;
generating a first intermediate feature by processing the mapped first edge using a neural network;
generating a first output feature by applying an inverse of the first group element to the first intermediate feature; and
generating an output inference based at least in part on the first output feature.

24. The non-transitory computer-readable medium of claim 23, the operation further comprising computing, for each respective edge in the input data, a respective group element to map the respective edge to the defined axis.

25. The non-transitory computer-readable medium of claim 23, wherein:
the first group element comprises a set of translations and a set of rotations that map the first edge to the defined axis, and
applying the first group element causes the second point to move to an origin in the multidimensional space and the first point to move to the defined axis of the multidimensional space at a distance r from the origin, wherein the distance r is defined based on a length of the first edge.

26. The non-transitory computer-readable medium of claim 23, wherein:
the neural network is an invariant message-passing network, and
the first output feature for the first point is generated further based on summing messages over a set of edges connected to the first point.

27. The non-transitory computer-readable medium of claim 23, wherein processing the mapped first edge using the neural network comprises:
determining a length of the first edge;
accessing a convolution kernel based on the length of the first edge, comprising, in response to determining that the convolution kernel was trained based on edges having lengths equal to the length of the first edge, determining to use the convolution kernel to process the mapped first edge; and
convolving one or more features of the second point with the convolution kernel.

28. The non-transitory computer-readable medium of claim 23, wherein processing the mapped first edge using the neural network comprises:
determining a length of the first edge;
accessing a convolution kernel based on the length of the first edge, comprising, in response to determining that no kernels in the neural network were trained based on edges having lengths equal to the length of the first edge:
accessing a first kernel trained based on edges shorter than the length of the first edge;
accessing a second kernel trained based on edges longer than the length of the first edge; and
generating the convolution kernel by interpolating between the first kernel and the second kernel; and
convolving one or more features of the second point with the convolution kernel.

29. The non-transitory computer-readable medium of claim 23, wherein the output inference corresponds to one or more of:
a segmentation of the plurality of points into objects, wherein the input data corresponds to light detection and ranging (LIDAR) data,
a predicted binding affinity of molecules, wherein the input data corresponds to molecular structures, or
a computer vision prediction, wherein the input data corresponds to image data.

30. A processing system, comprising:
means for accessing input data comprising a plurality of points in multidimensional space;
means for identifying an edge connecting a first point of the plurality of points and a second point of the plurality of points;
means for mapping the edge to a defined axis in the multidimensional space by applying a group element to the edge;
means for generating an intermediate feature by processing the mapped edge using a neural network; and
means for generating an output feature by applying an inverse of the group element to the intermediate feature; and
means for generating an output inference based at least in part on the output feature.
